(19) United States
(12) Patent Application Publication
(10) Pub. No.: US 2003/0222560 A1
(43) Pub. Date: Dec. 4, 2003

(54) Catalytically grown carbon fiber field emitters and field emitter cathodes made therefrom

(76) Inventor: David Herbert Roach, Hockessin, DE (US)

Correspondence Address: William Joseph Cotreau, E I du Pont de Nemours & Company, Legal Patents, Wilmington, DE, 19898, US

(21) Appl. No.: 10/258,252

(22) PCT Filed: May 22, 2001
(86) PCT No.: PCT/US01/16420

(51) Int. Cl. H01J 19/06; H01J 1/14

(52) U.S. Cl. 313/311

(57) ABSTRACT

This invention provides an electron field emitter and field emitter cathode comprised of carbon fibers grown from the catalytic decomposition of carbon-containing gases over small metal particles. Each carbon fibers has graphene platelets arranged at an angle with respect to the fiber axis so that the periphery of the carbon fiber consists essentially of the edges of the graphene platelets. These field emitters and field emitter cathodes are useful in computer, television and other types of flat panel displays.

### FIELD OF THE INVENTION

This invention relates to the use of carbon fibers grown from the catalytic decomposition of carbon-containing gases over small metal particles as an electron field emitter and particularly to their use in a field emitter cathode in display screens.

### BACKGROUND OF THE INVENTION

Field emission electron sources, often referred to as field emission materials or field emitters, can be used in a variety of electronic applications, e.g., vacuum electronic devices, flat panel computer and television displays, emission gate amplifiers, and klystrons and in lighting.

Display screens are used in a wide variety of applications such as home and commercial televisions, laptop and desktop computers and indoor and outdoor advertising and information presentations. Flat panel displays are only a few inches thick in contrast to the deep cathode ray tube monitors found on most televisions and desktop computers. Flat panel displays are a necessity for laptop computers, but also provide advantages in weight and size for many of the other applications. Currently laptop computer flat panel displays use liquid crystals, which can be switched from a transparent state to an opaque one by the application of small electrical signals. It is difficult to reliably produce these displays in sizes larger than that suitable for laptop computers.

Plasma displays have been proposed as an alternative to liquid crystal displays. A plasma display uses tiny pixel cells of electrically charged gases to produce an image and requires relatively large electrical power to operate.

Flat panel displays having a cathode using a field emission electron source, i.e., a field emission material or field emitter, and a phosphor capable of emitting light upon bombardment by electrons emitted by the field emitter have been proposed. Such displays have the potential for providing the visual display advantages of the conventional cathode ray tube and the depth, weight and power consumption advantages of the other flat panel displays. U.S. Pat. Nos. 4,857,799 and 5,015,912 disclose matrix-addressed flat panel displays using micro-tip cathodes constructed of tungsten, molybdenum or silicon. WO 94-15352, WO 94-15350 and WO 94-28571 disclose flat panel displays wherein the cathodes have relatively flat emission surfaces.

Field emission has been observed in two kinds of nanotube carbon structures. L. A. Chemozatonskii et al., Chem. Phys. Letters 233, 63 (1995) and Mat. Res. Soc. Symp. Proc. Vol. 359, 99 (1995) have produced films of nanotube carbon structures on various substrates by the electron evaporation of graphite in 10⁻⁵-10⁻⁶ Torr. These films consist of aligned tube-like carbon molecules standing next to one another. Two types of tube-like molecules are formed; the A-tubelites whose structure includes single-layer graphite-like tubules forming filaments-bundles 10-30 nm in diameter and the B-tubelites, including mostly multilayer graphite-like tubes 10-30 nm in diameter with conoid or dome-like caps. They report considerable field electron emission from the surface of these structures and attribute it to the high concentration of the field at the nanodimensional tips. B. H. Fishbine et al., Mat. Res. Soc. Symp. Proc. Vol. 359, 93 (1995) discuss experiments and theory directed towards the development of a buckytube (i.e., a carbon nanotube) cold field emitter array cathode.

N. M. Rodriguez et al., J. Catal. 144, 93 (1993) and N. M. Rodriguez, J. Mater. Res. 8, 3233 (1993) discuss the growth and properties of carbon fibers produced by the catalytic decomposition of certain hydrocarbons on small metal particles. The patents U.S. Pat. No. 5,149,584, U.S. Pat. No. 5,413,866, U.S. Pat. No. 5,458,784, U.S. Pat. No. 5,618,875 and U.S. Pat. No. 5,653,951 further disclose uses for such fibers.

There is a continuing need for a readily available electron field emitter for use in flat panel displays.

### SUMMARY OF THE INVENTION

This invention provides an electron field emitter comprised of carbon fibers grown from the catalytic decomposition of carbon-containing gases over small metal particles. Each carbon fibers has graphene platelets arranged at an angle with respect to the fiber axis so that the periphery of the carbon fiber consists essentially of the edges of the graphene platelets.

This invention also provides a field emitter cathode comprised of catalytically grown carbon fibers, i.e., carbon fibers grown from the catalytic decomposition of carbon-containing gases over small metal particles, attached to the surface of a substrate.

These field emitters and field emitter cathodes are useful in flat panel computer, television and other types of displays, vacuum electronic devices, emission gate amplifiers, klystrons and in lighting devices. The flat panel displays can be planar or curved.

### DETAILED DESCRIPTION OF THE INVENTION

This invention provides a novel electron field emitter, carbon fibers grown from the catalytic decomposition of carbon-containing gases over small metal particles, and an electron field emitter cathode comprised of these catalytically grown carbon fibers. These carbon fibers can be made as described in N. M. Rodriguez et al., J. Catal. 144, 93 (1993) and N. M. Rodriguez, J. Mater, Res. 8, 3233 (1993). Briefly, the powdered metal catalyst is reduced in a 10% hydrogen-helium stream at 600° C. and then brought to the desired reaction temperature. A predetermined mixture of hydrogen, hydrocarbon and inert gas is introduced into the system and the reaction proceeds. For example, a CO—H₂ (4:1) mixture can be reacted over iron at 600° C.

As used herein, “catalytically grown carbon fibers” means carbon fibers grown from the catalytic decomposition of carbon-containing gases over small metal particles, each of which carbon fibers has graphene platelets arranged at an angle with respect to the fiber axis so that the periphery of the carbon fiber consists essentially of the edges of the graphene platelets. The angle may be an acute angle or 90°.

The catalytically grown carbon fibers are good electron filed emitters and are most useful as a electron field emitter cathode when attached to a substrate.

Various processes can be used to attach catalytically grown carbon fibers to a substrate. The means of attachment must withstand and maintain its integrity under the conditions of manufacturing the apparatus into which the field emitter cathode is placed and under the conditions surrounding its use, e.g., typically vacuum conditions and temperatures up to about 450° C. As a result, organic materials are not generally applicable for attaching the particles to the substrate and the poor adhesion of many inorganic materials to carbon further limits the choice of materials that can be used.

A preferred method is to screen print a paste comprised of catalytically grown carbon fibers and glass frit, metallic powder or metallic paint or a mixture thereof onto a substrate in the desired pattern and to then fire the dried patterned paste. For a wider variety of applications, e.g., those requiring finer resolution, the preferred process comprises screen printing a paste which further comprises a photoinitiator and a photohardenable monomer, photopatterning the dried paste and firing the patterned paste.

The substrate can be any material to which the paste composition will adhere. If the paste is non-conducting and a non-conducting substrate is used, a film of an electrical conductor to serve as the cathode electrode and provide means to apply a voltage to and supply electrons to the catalytically grown carbon fibers will be needed. Silicon, a glass, a metal or a refractory material such as alumina can serve as the substrate. For display applications, the preferable substrate is glass and soda lime glass is especially preferred. For optimum conductivity on glass, silver paste can be pre-fired onto the glass at 500-550° C. in air or nitrogen. The conducting layer so-formed can then be over-printed with the emitter paste.

The emitter paste used for screen printing typically contains catalytically grown carbon fibers, an organic medium, solvent, surfactant and either low softening point glass frit, metallic powder or metallic paint or a mixture thereof. The role of the medium and solvent is to suspend and disperse the particulate constituents, i.e., the solids, in the paste with a proper rheology for typical patterning processes such as screen printing. There are a large number of such mediums known in the art. Examples of resins that can be used are cellulosic resins such as ethyl cellulose and alkyd resins of various molecular weights. Butyl carbitol, butyl carbitol acetate, dibutyl carbitol, dibutyl phthalate and terpineol are examples of useful solvents. These and other solvents are formulated to obtain the desired viscosity and volatility requirements. A surfactant can be used to improve the dispersion of the particles. Organic acids such oleic and stearic acids and organic phosphates such as lecithin or Gafac® phosphates are typical surfactants.

A glass frit that softens sufficiently at the firing temperature to adhere to the substrate and to the catalytically grown carbon fibers is required. A lead glass frit can be used as well as other glasses with low softening points such as calcium or zinc borosilicates. If a screen printable composition with higher electrical conductivity is desired, the paste also contains a metal, for example, silver or gold. The paste typically contains about 40 wt % to about 60 wt % solids based on the total weight of the paste. These solids comprise catalytically grown carbon fibers and glass frit and/or metallic components. Variations in the composition can be used to adjust the viscosity and the final thickness of the printed material.

The emitter paste is typically prepared by milling a mixture of catalytically grown carbon fibers, organic medium, surfactant, a solvent and and either low softening point glass frit, metallic powder or metallic paint or a mixture thereof. The paste mixture can be screen printed using well-known screen printing techniques, e.g., by using a 165-400-mesh stainless steel screen. The paste can be deposited as a continuous film or in the form of a desired pattern. When the substrate is glass, the paste is then fired at a temperature of about 350° C. to about 500° C., preferably at about 450° C., for about 10 minutes in nitrogen. Higher firing temperatures can be used with substrates which can endure them provided the atmosphere is free of oxygen. However, the organic constituents in the paste are effectively volatilized at 350-450° C., leaving the layer of composite comprised of catalytically grown carbon fibers and glass and/or metallic conductor. The catalytically grown carbon fibers undergo no appreciable oxidation or other chemical or physical change during the firing in nitrogen.

If the screen-printed paste is to be photopatterned, the paste contains a photoinitiator and a photohardenable monomer comprised, for example, of at least one addition polymerizable ethylenically unsaturated compound having at least one polymerizable ethylenic group.

Field emission tests were carried out on the resulting samples using a flat-plate emission measurement unit comprised of two electrodes, one serving as the anode or collector and the other serving as the cathode. The cathode consists of a copper block mounted in a polytetrafluoroethylene (PTFE) holder. The copper block is recessed in a 1 inch by 1 inch (2.5 cm×2.5 cm) area of PTFE and the sample substrate is mounted to the copper block with electrical contact being made between the copper block and the sample substrate by means of copper tape. A high voltage lead is attached to the copper block. The anode is held parallel to the sample at a distance, which can be varied, but once chosen it was held fixed for a given set of measurements on a sample. Unless stated otherwise was a spacing of 1.25 mm was used. The anode consists of a glass plate coated with indium tin oxide deposited by chemical vapor deposition. It is then coated with a standard ZnS-based white phosphor, Phosphor P-31, Type 139 obtained from Electronic Space Products International. An electrode is attached to the indium tin oxide coating.

The test apparatus is inserted into a vacuum system, and the system was evacuated to a base pressure below 1×10⁻⁶ torr (1.3×10⁻⁴ Pa). A negative voltage was applied to the cathode and the emission current was measured as a function of the applied voltage.

### EXAMPLE OF THE INVENTION

Catalytically grown carbon fibers were obtained as a powder from Catalytic Materials Ltd, 12 Old Stable Drive, Mansfield, Mass. 0.1513 grams of these catalytically grown carbon fibers were added to 0.1502 grams of glass, Bayer PK 8701 (CAS Registry No. 65997-18-4), and 1.5012 grams of a typical organic medium composed primarily of ethylcellulose in terpineol. These ingredients were mixed on a glass plate muller for 75 rotations to form the emitter paste. A pre-fired silvered glass substrate was prepared by screen printing a mixture of silver powder and a low melting glass frit in a typical organic ethylcellulose-based medium, followed by firing at 525° C. The 1 cm² square pattern of emitter paste was then screen printed onto the pre-fired silvered glass substrate using a 325 mesh screen and the sample was subsequently dried at 120° C. for 10 minutes. The dried sample was then fired in nitrogen for 10 minutes at 450° C. After firing the paste forms an adherent coating on the substrate. The fired sample was tested for field emission as described in the specification. The emission current was in excess of 10⁻⁹ amp at an applied voltage of 4500 V.

What is claimed is:

1. An electron field emitter comprised of carbon fibers grown from the catalytic decomposition of carbon-containing gases over small metal particles, each of which said carbon fibers has graphene platelets arranged at an angle with respect to the fiber axis so that the periphery of said carbon fiber consists essentially of the edges of said graphene platelets.

2. The electron field emitter of claim 1 wherein said angle is an acute angle.

3. The electron field emitter of claim 1 wherein said angle is 90°.

4. An electron field emitter cathode comprised of catalytically grown carbon fibers attached to a substrate.
